(19) United States
(12) Patent Application Publication
(10) Pub. No.: US 2007/0147213 A1
(43) Pub. Date: Jun. 28, 2007

(54) Optical information carrier containing bragg reflectors

(75) Inventors: Rifat Ata Mustafa Hikmet, Eindhoven (NL); Marcello Leonardo Mario Balistreri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/561,475

(22) PCT Filed: Jun. 23, 2004
(86) PCT No.: PCT/IB04/50975

§ 371 Date: Dec. 20, 2005

(30) Foreign Application Priority Data
Jun. 26, 2003 (EP) 03101897.1

(51) Int. Cl. G11B 7/20

(52) U.S. Cl. 369/94; 369/275.1

(57) ABSTRACT

The invention refers to an optical information carrier (1) for carrying information to be read out by means of an optical beam (9) having at least one information layer (6). It is an object of the invention to provide information carriers (1) with improved collection efficiency. To achieve this object the at least one information layer (1) contains Bragg reflectors for reflecting light of the optical beam (9), when said Bragg reflector is heated above a reflectance threshold temperature by said optical beam.

The present invention relates to an optical information carrier, to a read-out device for the optical information carrier and to a writing device for writing information on an optical information carrier. The invention also relates to a method for reading out information from an optical information carrier and to a method for writing information on said optical information carrier.

There is a growing demand in reliable optical information carriers of digital information for computers, video systems, multimedia, etc. This information carriers should have high capacity.

Currently required storage capacities make the use of three-dimensional storing necessary. Current multi-layer technologies, as for instance known from U.S. Pat. No. 6,099,065, use fluorescent material as storage material. Information layers are separated by thick spacer layers. In these multi-layer discs a plurality of information layers is stacked. In multi-layer discs information layers have to be addressed and selected for writing and reading out. Said layers can be addressed for writing/reading by focusing a writing/reading laser beam on it. Selectivity for writing is achieved by the writing laser beam intensity at the focal spot being much higher than in the non-addressed layers, thereby heating up only the desired spot above the threshold temperature and degrading the fluorescent active material to fluorescent inactive material.

Reading out an addressed layer can be achieved by focusing the reading beam on it. Reading out data from a 3D optical data carrier by one focused reading laser beam is inevitably followed by fluorescence of a large number of fluorescent sections from non-addressed layers confined within the conical surface of the focused reading laser beam. Read-out selectivity can be achieved by use of electronic filter means separating detected signals into high and low frequency components. High frequency components represent data signals from the in-focus layer, and the low frequency part is responsible for background noise coming from all out-of-focus layers.

Fluorescent emission can be detected by collectors. A disadvantage of the described multi-layer technology is the low collection efficiency of the isotropic emission. Other disadvantages are the use of additional electronic filter means and large background noise.

It is therefore an object of the present invention to provide an optical information carrier, which can be read out more easily. It is further an object of the invention to provide a read-out device and method providing a higher collection efficiency, as well as to provide a writing device and method for said optical information carrier.

This object can be achieved by an optical information carrier for carrying information to be read out by means of an optical beam comprising at least one information layer containing material having Bragg reflector characteristics for reflecting light of said optical beam, when said material is heated above a reflectance threshold temperature by said optical beam.

The present invention uses reflectance characteristics of optically active material instead of isotropic fluorescence as described in the art. Reflected light is highly directional. An optical beam incidenting in an angle of incidence on the optical information carrier causes reflection from the optical information carrier in the angle of reflection. Nearly all of the reflected light can be easily collected by appropriate collectors. This is an improvement compared to fluorescent storage information carriers, where only about 4% of the isotropic emission can be collected using an objective lens with a numerical aperture of NA=0.6.

An information carrier contains at least one information layer. The material having Bragg reflector characteristics is transparent for the optical beam wavelength at ambient temperature. Bragg reflectors are thermoreflective material. While heating said Bragg reflector above a reflection threshold temperature the reflectance band of the Bragg reflector is shifted to a position where it comprises the wavelength of the optical beam. Consequently, the heated Bragg reflector reflects incidenting optical beam light. The reflected light can be collected and evaluated.

Material having said reflectance characteristics can contain liquid crystal. Cholesteric liquid crystal and liquid crystal in the so called blue phase show a reflectance band. The position of the reflectance band depends on the temperature. The reflectance band can be shifted to higher wavelengths with increasing temperature or to lower wavelengths with increasing temperature depending on the choice of the cholesteric liquid crystal. There are liquid crystals having the characteristic of altering the width of the reflectance band depending on the temperature.

Bragg reflectors can also be obtained by alternating layers with different refractive indices. In this case each layer can contain block copolymers.

The crystal and alternating layers consisting of block copolymers are known in the art and are commercially available.

Preferably, the optical information carrier contains at least two information layers and at least one spacer layer separating the at least two information layers and being transparent for the optical beam.

In this embodiment of the invention the storage capacity is enlarged at least by a factor two. For information carriers containing a plurality of information layers the capacity can be enlarged correspondingly. Thermoreflective Bragg reflectors are suitable especially for a multi-layer information carrier in combination with a focused optical reading beam. The focal spot of the focused optical beam is hot enough to shift the reflectance band of the Bragg reflector so that it comprises the wavelength of the optical beam. Outside the focal spot the temperature is too low to shift the reflectance band sufficiently. The Bragg reflector at ambient temperature is transparent for the optical beam. Therefore, the optical beam can cross all information layers without much loss and is reflected only by the heated Bragg reflector in the focal spot of the beam. Because the spacer layers in multi-layer optical information carriers isolate the information layers to each other thermally, only the Bragg reflector within the focal spot is heated above the reflectance threshold temperature reducing background noise compared to the art.

The object is further achieved by a read-out device for reading out information from an optical information carrier, which comprises at least one information layer containing material having Bragg reflector characteristics for reflecting light of an optical beam, when said material is heated above a reflectance threshold temperature, said device comprising a light source emitting said optical beam, which can be directed onto said optical information carrier producing a temperature above said reflectance threshold temperature.

Read-out device and information carrier have to be engineered with respect to each other. Especially intensity and wavelength of the optical beam on the one hand and the Bragg reflector characteristics on the other hand are adapted to each other. The Bragg reflector at ambient temperature is transparent for the optical beam. The intensity of the optical beam has to be selected such that the focused optical beam is hot enough to heat the Bragg reflector above the reflection threshold temperature. Focusing can be achieved by appropriate means for focusing, e.g. an adjustable objective lens. Heating the Bragg reflector results in a shift of the reflectance band of the Bragg reflector. The type of the Bragg reflector is selected such that the heated and e.g. therefore shifted reflection band comprises the optical beam wavelength. The reflected signal can easily be detected. The information carrier can be read out many times leading to a so-called ROM application of the invention.

For read-out the position of the optical information carrier is stabilized by seating the information carrier in a receptacle. Preferably, the information carrier rotates in the receptacle. While being read out the reading beam is running along written tracks of the information carrier and the sequence of reflection and non reflection is detected by a detector and can be evaluated by an appropriate evaluation device.

Advantageously, a laser beam is chosen for the optical beam. Laser light has a very small spectral width. The type of Bragg reflector is selected such that the laser wavelength is comprised by the reflection band of the heated Bragg reflector.

The object of the invention is further achieved by a method for reading out information from an optical information carrier, which comprises at least one information layer containing material having Bragg reflector characteristics for reflecting light of an optical beam, when the material is heated above a reflectance threshold temperature, comprising the steps of directing said optical beam on said information carrier for heating said material above said reflectance threshold temperature, detecting signals being reflected by said heated material and evaluating said detected signals.

The method can be carried out with the read-out device described above. Preferably, the optical beam is focused on one of said information layers for heating said material above said reflectance threshold temperature. The focused beam heats only the material within the focal spot above said threshold reducing background noise from other layers.

The object of the invention is also achieved by a writing device for writing information on an optical information carrier, which comprises at least one information layer containing material having Bragg reflector characteristics comprising a light source emitting an optical beam to be directed onto said optical information carrier for changing reflection characteristics of said material.

Surprisingly, it was found that writing optical information carriers containing Bragg reflectors can be achieved by directing an optical beam on said Bragg reflector to change its reflection characteristics permanently.

UV light can be directed on cholesteric liquid crystal used as Bragg reflector changing a pitch of said material resulting in an altered reflection characteristic.

Preferably, the optical beam produces a temperature above a degrading temperature threshold of said Bragg reflector for degrading said Bragg reflector.

Unwritten optical information layers according to the invention can have grooves containing Bragg reflector material. For writing information on the information layer sections of the grooves are heated above the degrading temperature threshold of said Bragg reflector. Exceeding the degrading temperature results in the change of the reflection characteristics. The once degraded Bragg reflectors looses its Bragg reflector characteristics permanently. The degraded Bragg reflector becomes transparent for optical beam light.

The described information carrier can be written once and read out many times. This is the WORM application of the described invention.

The object of the invention is also achieved by a method for writing information on an optical information carrier, which comprises at least one information layer containing material having Bragg reflector characteristics comprising the step of directing an optical beam on said optical information carrier for changing reflection characteristics of said material.

Preferably, said material is heated above a degrading temperature threshold of said material.

The invention will now be explained in more detail with reference to the drawings, in which:

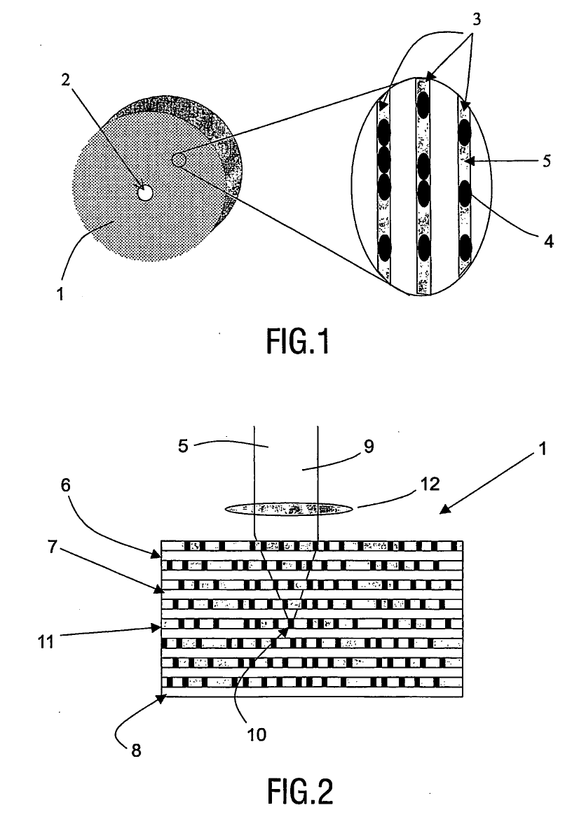

FIG. 1 shows a perspective view of a multi-layer disc and a magnification of a cut-out showing written tracks,

FIG. 2 shows a cross-section of the multi-layer disc in FIG.1,

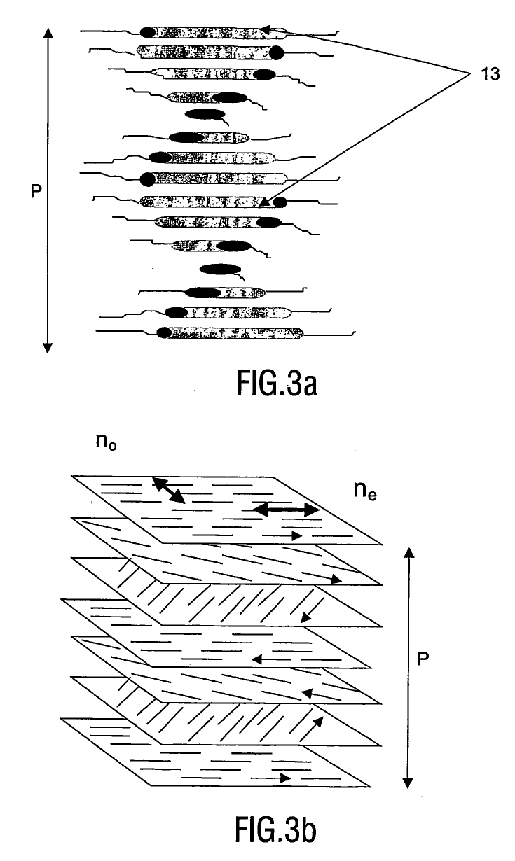

FIG. 3a and FIG. 3b show a helix of a cholesteric phase and a view indicating the sense of the corresponding helix,

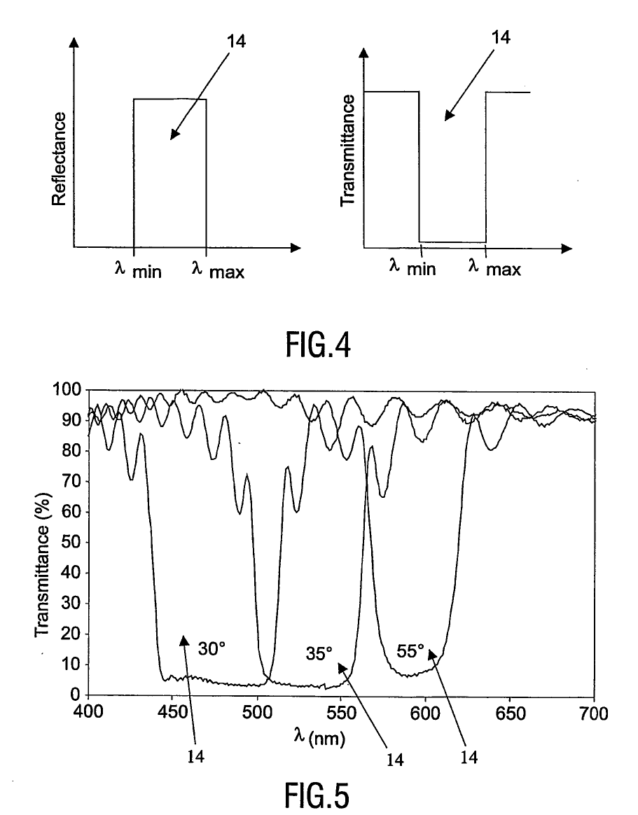

FIG. 4 shows reflectance and transmittance characteristics of the cholesteric phase according to FIG. 3,

FIG. 5 shows a transmittance/wavelength diagram for cholesteric phase depending on the temperature,

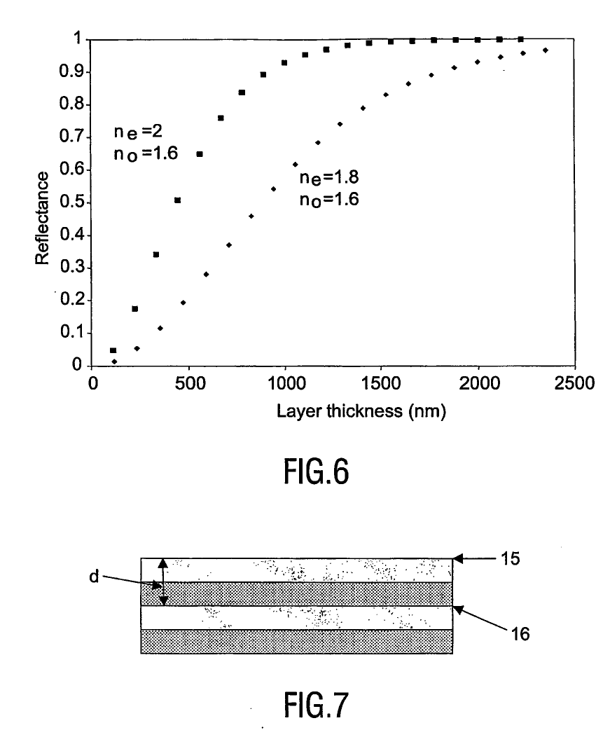

FIG. 6 shows a reflectance/layer thickness diagram of cholesteric phase,

FIG. 7 shows a Bragg reflector consisting of alternating layers,

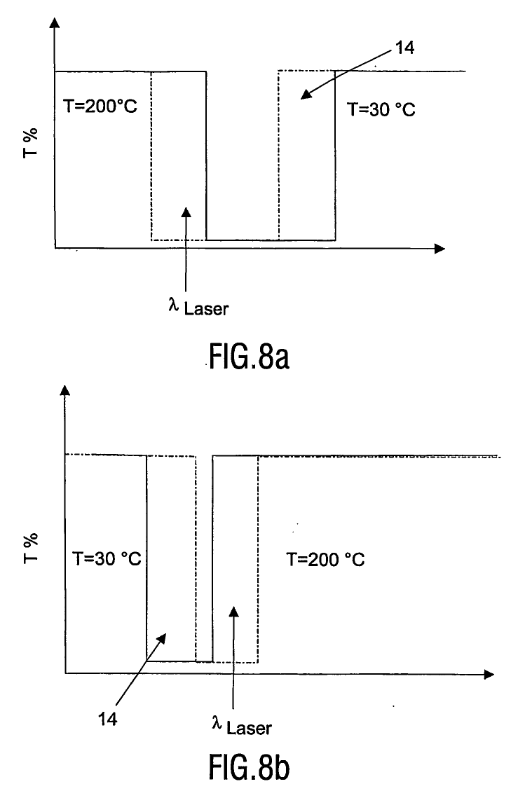

FIG. 8a and FIG. 8b show temperature dependence of the transmittance of the Bragg reflector according to FIG. 7,

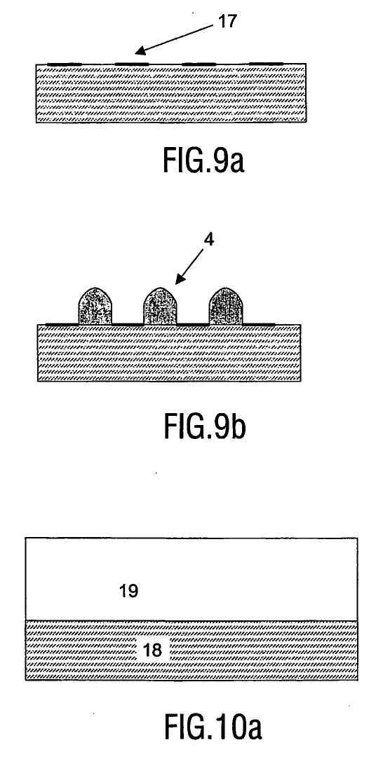

FIG. 9a and FIG. 9b show steps of a surface treatment method to produce a disc according to the invention,

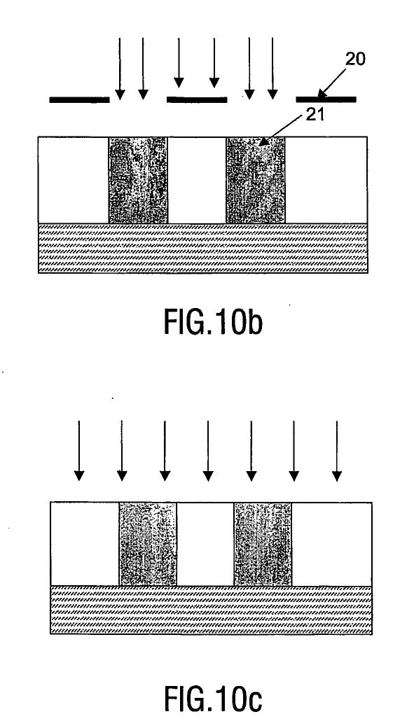

FIG. 10a, FIG. 10b and FIG. 10c show a radiation method to produce a disc according to the invention.

The information carrier in FIG. 1 is a disc (CD or DVD) 1 according to the invention. A central hole 2 is adapted to receive a spigot (not shown) for stabilizing a position of the disc during rotation. The disc contains information layers stacked parallel to each other along a rotation axis of the disc 1. Each information layer comprises tracks 3 encircling the hole 2, concentrically. In FIG. 1 the magnified cut-out shows three parallel sections of three tracks 3. The tracks 3 contain optically active material 4 and optically inactive material 5. Binary information is stored by the distribution, more precisely the sequence of the optically active material spots 4 and optically inactive material areas 5.

The disc 1 contains a plurality of stacked information layers 6. In FIG. 2 a disc 1 having eight information layers 6 separated by seven spacer layers 7 is shown. A top information layer is covered by a cover layer (not shown). A bottom layer is a substrate layer 8. Stored information is read-out by focusing a laser beam 9 onto a focal spot 10 in an in-focus information layer 11 according to FIG. 2. The focal spot 10 is circular and its diameter is about the size of the track width. The intensity of the focused laser beam 9 in the focal spot 10 is adapted to stimulate the optically active material spots 4. Optically active material spots in out-of-focus information layers is not stimulated enough because of lack of intensity.

If the focal spot 10 coincides with spots 4 containing optically active material, the stimulated optically active material reflects radiation, which can be detected by a detector (not shown) and evaluated by an evaluation device (not shown). If the focal spot 10 coincides with optically inactive material areas 5, no detectable reflection occurs. The laser beam 9 is focused by means of an adjustable objective lens 12 onto an information layer 6 turning that information layer 6 into the in-focus information layer 11. In this embodiment of the invention the adjustable objective lens 12 also serves as collector for the reflected light by the optically active material spots 4. The numerical aperture of the objective lens 12 is about NA=0.6. The spacer layers 7 thermally isolate the information layers 6 to each other. They are transparent for the wavelength of the laser light. For reading out the disc 1 it is rotatably seated in an appropriate receptacle (not shown).

According to the invention the optically active material in the spots 4 has Bragg reflector characteristics. Bragg reflectors are thermoreflective. The position of their reflectance band dependents on the temperature of the material. At ambient temperature the Bragg reflector does not reflect or the reflection band does not overlap with the wavelength of the laser beam. If the Bragg reflector is heated, the reflectance band shifts and overlaps with the wavelength of the laser. In this embodiment of the invention the Bragg reflector is chosen such that it is transparent for the wavelength of the laser beam 9 at ambient temperature. The Bragg reflector within the focal spot 10 of the focused laser beam 9 is heated above a reflection threshold temperature such that the wavelength of the laser beam will be reflected by the heated Bragg reflector. The out-of-focus information layers stay transparent for the wavelength of the laser because the reflectance band is not shifted. Thus, the reflected light can cross all layers 6, 7 without much loss and a strong reflection signal can be detected. Characteristics of different Bragg reflectors are described below.

In one embodiment of the invention the Bragg reflector is a cholesteric phase according to FIG. 3a. Cholesteric liquid crystal phase is obtained when a nematic liquid crystal is doped with so called chiral molecules. Chiral molecules are asymmetrically substituted molecules which are not the same as their mirror image. Liquid crystal consist of rod-like molecules 13. A director, indicated by an arrow, is indicating the mean orientation direction of the molecules 13. The cholesteric phase is defined by a helical superstructure. In the cholesteric phase the position of the reflection band can show a change when a temperature is altered. In the cholecteric phase the director rotates about a helix. FIGS. 3a and 3b indicate the rotation direction of the director A pitch p of a single helix is defined as the distance over which the director rotates 360°. nₒ and nₑ are the extraordinary and ordinary refractive indices of a uniaxially oriented phase, respectively.

A reflectance band 14 is shown in FIG. 4. The transmittance is complementary to the reflectance. Upper λₘₐₓ and lower λₘᵢₙ boundaries of the reflectance band are λₘᵢₙ=p·nₒ and λₘₐₓ=p·nₑ, respectively. The reflectance bandwidth Δλ is therefore given by Δλ=λₘᵢₙ−λₘₐₓ=p·(nₑ−nₒ).

Essential for the present invention is the temperature dependence of the reflectance band 14. FIG. 5 shows the transmittance plotted against the wavelength of incident light for different material temperatures, namely 30° C., 35° C. and 55° C. The cholesteric is a monomeric mixture, commercially available as BL59 containing 25% CB15 and 20% CC6. At a temperature of 30° C. nearly all light between ca. 450 and ca. 500 nm is reflected by the cholesteric liquid crystal. At 35° C. the aforementioned wavelength are crossing the material and wavelengths between ca. 500 and ca. 550 nm are reflected. At 55° C. wavelength between ca. 570 and ca. 630 nm are reflected all other wavelengths transmit the cholesteric liquid crystal.

It is essential for the invention that the wavelength of the laser beam 9 and the intensity of the laser beam 9 in the focal spot 10 on the one hand and the type of liquid crystal in the cholesteric phase on the other hand are selected referring to each other. A usable read-out power is 5 mW for a 405 nm laser. At ambient temperature the cholesteric phase has to be transparent for the wavelength of the laser beam 9. The laser beam 9 is focused onto a focal spot 10. The cholestric phase in the optically active material spots 4 exposed to the focal spot 10 is heated above a reflection threshold temperature. At that temperature the cholesteric phase reflects the laser light 9. The reflected laser light can be detected and evaluated.

In order to get a sufficient reflection intensity the cholesteric phase layer should be as thick as possible. FIG. 6 shows a diagram with the maximum reflectance plotted as a function of layer thickness for different refraction indices. In FIG. 6 it can be seen that a reflectance of more than 40% can be obtained for a sample with a thickness of ca. 800 nm. The calculation for the diagram is valid for light in one circular polarization state. When unpolarized light is used reflectance is decreased by a factor of two.

For the multi-layer disc 1 there are some requirements regarding the absorption and the transmission of the in-focus information layer 11 and the out-of-focus information layers due to signal fan-out of the signal intensity for the deeper lying layers. The absorption of the out-of-focus information layer should be <2% and the absorption of the in-focus information layer should be sufficient to increase the temperature above the reflection threshold temperature, e.g. 200° C. Another requirement refers to the track width. If laser light of 405 nm is used and the numerical aperture of the objective lens 12 is NA=0.6 a track width of 400 nm is needed.

There are different ways to manufacture the disc 1 containing cholesteric phase. A substrate with the necessary pit distribution can be used. The pits can be filled using spin coating.

A second method to produce a disc 1 with the necessary distribution of cholesteric phase is surface treatment according to FIGS. 9a and 9b. Predetermined areas 17 of the surface are selected and treated in FIG. 9a. After having done the surface treatment the cholesteric phase is applied to the treated surface and deposits on the untreated areas producing the required cholesteric phase spots 4 shown in FIG. 9b.

Thirdly, a cholesteric phase changing its pitch under the influence of UV radiation and/or heat can be used according to FIGS. 10a, 10b, 10c. A substrate 18 can be deposited with a cholesteric phase layer 19 and a template 20 can overlay the deposited cholesteric phase layer 19. UV radiation or heat is emitted onto the template and changes the pitch of the cholesteric phase underneath transparent areas of the template 21 as shown in FIG. 10b. Finally the treated cholesteric phase layer 19 is fixed by flood exposure according to FIG. 10c.

Unwritten discs containing grooves filled with cholesteric phase can be written by exposing them to a writing laser beam with an intensity to degrade predetermined areas. The degraded cholesteric phase permanently looses its Bragg characteristics. A usable writing beam power is 20 mW for a 405 nm laser. As a result tracks of sections containing cholesteric phase and sections containing degraded material are obtained with the information stored in the sequence of cholesteric phase and degraded material along the tracks.

In a second embodiment of the invention Bragg reflectors are made of alternating layers 15, 16 with different refractive indices n₁ and n₂. A layer 15 with a refractive index n₁ and an adjacent layer 16 with a refractive index of n₂ have a thickness of d as shown in FIG. 7. Such Bragg reflectors can be obtained by using block copolymers which show lamellar phase. For a Bragg reflector with negative reflection coefficient the position of the reflectance band 14 moves from higher to lower wavelength with increasing temperature as shown in FIG. 8a. Bragg reflectors with positive reflection coefficient show the reverse characteristic as shown in FIG. 8b. There the reflectance band 14 moves from higher to a lower wavelength with decreasing temperature. An appropriate choice of the laser beam wavelength is indicated by the two arrows λₗₐₛₑᵣ.

In current multi-layer discs fluorescent material is used to store information. Fluorescence is isotropic resulting in a low collection efficiency of such systems. To improve the collection efficiency Bragg reflectors can be used as storage material. Bragg reflectors reflect signals instead of absorbing incident light and emitting light of a different wavelength. The reflected signals are directed and have a higher intensity improving the collection efficiency.

1. Optical information carrier (1) for carrying information to be read out by means of an optical beam (9) comprising:
at least one information layer (6) containing material having Bragg reflector characteristics for reflecting light of said optical beam (9), when said material is heated above a reflectance threshold temperature by said optical beam (9).

2. Optical information carrier (1) as claimed in claim 1, characterized in that said material contains liquid crystal.

3. Optical information carrier (1) as claimed in claim 1, characterized in that said material contains cholesteric liquid crystal.

4. Optical information carrier (1) as claimed in claim 1, characterized in that said material contains liquid crystal in the blue phase.

5. Optical information carrier (1) as claimed in claim 1, characterized in that said material contains alternating layers (15, 16) with different refractive indices.

6. Optical information carrier as claimed in claim 5, characterized in that each layer (15, 16) contains block copolymers.

7. Optical information carrier as claimed in claim 1, characterized by at least two information layers (6) and at least one spacer layer (7) separating said at least two information layers (6) and being transparent for said optical beam (9).

8. Read-out device for reading out information from an optical information carrier (1), which comprises at least one information layer (6) containing material having Bragg reflector characteristics for reflecting light of an optical beam (9), when said material is heated above a reflectance threshold temperature, comprising:
a light source emitting said optical beam (9), which can be directed onto said optical information carrier (1), producing a temperature above said reflectance threshold temperature.

9. Read-out device as claimed in claim 8, characterized by focussing means (12) for focusing said optical beam (9) on a focal spot (10) having a temperature above said reflectance threshold temperature on said at least one information layer (6).

10. Read-out device as claimed in claim 8, characterized by at least one detector for detecting light reflected by said material having Bragg reflector characteristics.

11. Writing device for writing information on an optical information carrier (1), which comprises at least one information layer (6) containing material having Bragg reflector characteristics comprising:
a light source emitting an optical beam (9) to be directed onto said optical information carrier (1) for changing reflection characteristics of said material.

12. Writing device as claimed in claim 11, characterized in that said optical beam produces a temperature above a degrading temperature threshold of said material for degrading said Bragg reflector.

13. Writing device as claimed in claim 11, characterized by focussing means for focusing said optical beam (9) on a focal spot (10) on said at least one information layer.

14. Method for reading out information from an optical information carrier (1), which comprises at least one information layer (6) containing material having Bragg reflector characteristics for reflecting light of an optical beam (9), when the material is heated above a reflectance threshold temperature comprising the steps of:
directing said optical beam on said information carrier for heating said material above said reflectance threshold temperature,
detecting signals being reflected by said heated material and
evaluating said detected signals.

15. Method as claimed in claim 14, characterized by focusing an optical beam (9) on a focal spot (10) in one of said information layers (6) for heating said material above said reflectance threshold temperature.

16. Method for writing information on an optical information carrier (1), which comprises at least one information layer (6) containing material having Bragg reflector characteristics comprising the steps of:
directing an optical beam (9) on said optical information carrier (1) for changing reflection characteristics of said material.

17. Method as claimed in claim 16, characterized by heating said material above a degrading temperature threshold of said material degrading said material.

18. Method as claimed in claim 16, characterized by focusing said optical beam (9) on a focal spot (10) on said at least on information layer for heating said material above said degrading temperature threshold.
